(19) United States
(12) Patent Application Publication
(10) Pub. No.: US 2023/0142445 A1
(43) Pub. Date: May 11, 2023

(54) HOUSEHOLD DISHWASHER

(71) Applicant: PRIME.CO.,LTD., Incheon (KR)

(72) Inventors: SUNG HYUN KIM, Incheon (KR); SUNG WOO KIM, Seoul (KR)

(21) Appl. No.: 17/522,476

(22) Filed: Nov. 9, 2021

(30) Foreign Application Priority Data
Nov. 8, 2021 (KR) 10-2021-0152575

(51) Int. Cl. A47L 15/13; A47L 15/00; A47L 15/22; A47L 15/42

(52) U.S. Cl. CPC A47L 15/13; A47L 15/0005; A47L 15/0007; A47L 15/0015; A47L 15/22; A47L 15/4234; A47L 15/4242; A47L 15/4278

(57) ABSTRACT

A household dishwasher includes a washing tub, a main body, a door portion configured to open and close an upper surface of the washing tub, a first washing water spray nozzle configured to spray washing water supplied from a door portion water supply pipe to an inside of the washing tub, a second washing water spray nozzle configured to spray the washing water to the inside of the washing tub, a steam generator configured to supply steam to the inside of the washing tub, an ultrasonic vibration part configured to apply ultrasonic vibration to the washing water inside the washing tub such that an ultrasonic washing is performed, and a controller configured to receive a washing command signal of a user and control internal components of the household dishwasher.

### CROSS REFERENCE TO RELATED APPLICATION

The present application claims priority under 35 U.S.C 119(a) to Korean Patent Application No. 10-2021-0152575, filed Nov. 8, 2021, the entire contents of which is incorporated herein for all purposes by this reference.

### BACKGROUND

### Field of the Invention

The present disclosure relates to a household dishwasher that has improved washing performance.

### Description of the Related Art

Generally, a household dishwasher is a home appliance configured to wash off food residues stuck on surfaces of dishes by using high-pressure washing water sprayed from a spray nozzle. Unlike a medium-sized or large-sized dishwasher for commercial use, the household dishwasher has space constraints and is specialized in washing small quantities of the dishes, and is thus manufactured in a compact structure. Currently, the demand for the household dishwasher is increasing due to the convenience of using the household dishwasher.

The household dishwasher mainly provided on the market includes a tub in which a washing tub is formed and a sump mounted on a bottom surface of the tub where the washing water is stored. In addition, the washing water is moved to a spray nozzle by a pumping action of a washing pump that is mounted inside the sump, then the washing water moved to the spray nozzle is sprayed at high-pressure through a spraying port, and then the washing water sprayed at the high-pressure collides with the surfaces of the dishes, so that residues such as food residues stuck on the dishes fall to the bottom of the tub.

However, in the household dishwasher of a high-pressure washing water spraying type using the existing washing water spray nozzle has a blind spot where the washing water at the high-pressure does not reach between the dishes accommodated in the rack, so that the washing is not performed well and not uniformly performed throughout the dishes accommodated in the washing tub. Further, an additional washing is required to be performed since there is a situation in which some parts that are incompletely washed often exists, and when the dishes are placed on the rack, there is an inconvenience of standing and placing each of the dishes at an angle that is advantageous for performing the washing in order to reduce the blind spot where the washing water at the high-pressure does not reach to the dishes.

### SUMMARY

Accordingly, the present disclosure has been made keeping in mind the above problems occurring in the related arts, and the present disclosure is intended to propose a household dishwasher in which a washing process is well and uniformly performed throughout entire dishes since a blind spot of the washing is not formed comparing to an existing household dishwasher of a high-pressure washing water spraying type, and is intended to propose a household dishwasher in which there is no need to pay attention to standing each of the dishes at an angle advantageous for performing the washing when the dishes are placed on a rack.

The technical problem to be solved by the present disclosure is not limited to the above-mentioned problem and other problems which are not mentioned will be clearly understood by those skilled in the art from the following description.

In order to achieve the objectives of the present disclosure, a household dishwasher of the present disclosure is provided with a washing tub where an object to be washed is accommodated and washed, and a main body accommodating the washing tub in a structure that the washing tub is capable of being pulled in and out through an opening portion that is formed in the front of the main body. In addition, the household dishwasher further includes: a door portion formed on an upper surface of the washing tub and configured to open and close the upper surface of the washing tub; a first washing water spray nozzle provided at the door portion and configured to spray washing water supplied from a door portion water supply pipe to an inside of the washing tub; a second washing water spray nozzle provided at a lower surface of an inner surface of the washing tub and configured to spray the washing water to the inside of the washing tub; a steam generator provided in the washing tub and configured to supply steam to the inside of the washing tub by using the washing water supplied from the first and second washing water spray nozzles; an ultrasonic vibration part provided at an outer surface of the washing tub and configured to apply ultrasonic vibration to the washing water inside the washing tub such that an ultrasonic washing is performed; and a controller provided inside the main body and configured to receive a washing command signal of a user and control an operation relationship between internal components of the household dishwasher.

According to the household dishwasher of the present disclosure, compared to the existing household dishwasher of the high-pressure washing water spraying type, the washing performance of the household dishwasher of the present disclosure may be improved since the washing is uniformly performed throughout the dishes without forming the blind spot of the washing. Further, the household dishwasher of the present disclosure has an advantage that the convenience of use may be improved since there is no need to pay attention to standing each of the dishes at an angle advantageous for performing the washing.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating a household dishwasher according to an embodiment of the present disclosure;

FIG. 2 is a side cross-sectional view illustrating the household dishwasher according to an embodiment of the present disclosure;

FIG. 3 is an exploded perspective view illustrating a state in which some components of the household dishwasher according to an embodiment of the present disclosure are separated from each other so as to illustrate an inner portion of the household dishwasher; and

FIG. 4 is a view illustrating a door portion of the household dishwasher according to an embodiment of the present disclosure.

### DETAILED DESCRIPTION

The present disclosure relates to a household dishwasher. The household dishwasher includes a washing tub where an object to be washed is accommodated and washed and a main body accommodating the washing tub that is capable of being pulled in and out through an opening portion that is formed in the front of the main body. The household dishwasher also includes: a door portion formed on an upper surface of the washing tub and configured to open and close the upper surface of the washing tub; a first washing water spray nozzle provided at the door portion and configured to spray washing water supplied from a door portion water supply pipe to an inside of the washing tub; and a second washing water spray nozzle provided at a lower surface of an inner surface of the washing tub and configured to spray washing water to the inside of the washing tub. The household dishwasher further includes: a steam generator provided in the washing tub and configured to supply steam to the inside of the washing tub by using washing water supplied from the first and second washing water spray nozzles; an ultrasonic vibration part provided at an outer surface of the washing tub and configured to apply ultrasonic vibration to the washing water inside the washing tub such that an ultrasonic washing is performed; and a controller provided inside the main body and configured to receive a washing command signal of a user and control an operation relationship between internal components.

The washing tub is a place where the objects to be washed, such as dishes, spoons, chopsticks, and the like, are accommodated and washed. In the present disclosure, the washing tub is a pond-type washing tub where washing of the objects to be washed is performed when water is filled up to a substantial portion in the washing tub. Further, since there is a problem that the water is leaked to the outside when a door is opened and closed while the water is filled up to the substantial portion in the washing tub, it is preferable that the door portion formed on the upper surface of the washing tub and configured to open and close the upper surface of the washing tub is provided.

The main body forms a body of the household dishwasher while accommodating the washing tank. In the present disclosure, the main body accommodates the washing tub in a structure that the washing tub is capable of being pulled in and out through the opening portion that is formed in the front of the main body, and the washing tub is coupled to an inner portion of the main body by applying various known methods such as a sliding method. In addition, in order to prevent the household dishwasher from falling frontward since load is excessively concentrated frontward when the washing tub is pulled out frontward from the main body while the washing tub is fully filled with dishes, it is preferable that a leaning prevention portion is provided at the lower surface portion of the washing tub. Any structure capable of supporting the household dishwasher so that the household dishwasher is prevented from falling frontward may be applied to the structure of the leaning prevention portion. However, it is preferable to apply the structure which is folded when the washing tub is accommodated in the main body and which is supported by a floor surface on which the household dishwasher is placed by being automatically unfolded when the washing tub is pulled out to the outside of the main body.

In the present disclosure, the first washing water spray nozzle is provided at the door portion, and is configured to spray washing water supplied from the door portion water supply pipe to the inside of the washing tub. Further, even when the washing water is filled to the highest level in the washing tub, the first washing water spray nozzle is operated without being submerged in the washing water. Since the door portion water supply pipe has to respond flexibly to an opening and closing operation of the door portion, it is preferable that the door portion water supply pipe is formed of a material having elasticity and flexibility.

In the present disclosure, the second washing water spray nozzle is provided at the lower surface of the inner surface of the washing tub, and is configured to spray washing water to the inside of the washing tub. Further, in order to enable the second washing water spray nozzle to form vortices and bubbles in the washing water that is contained in the washing tub so as to perform the washing of the dishes, the second washing water spray nozzle is operated while being submerged in the washing water when the washing water is contained in the washing tub.

In the household dishwasher of the present disclosure, washing and rinsing of the dishes accommodated in the washing tub are performed by spraying the washing water to the inside of the washing tub through the first and second washing water spray nozzles. In addition, when the washing water is supplied to an inner space of the washing tub by the first and second washing water spray nozzles, steam may be generated by using the washing water contained in the inner space of the washing tub or the ultrasonic washing is performed by applying ultrasonic vibration to the washing water.

The first and second washing water spray nozzles are configured such that the washing water pumped and supplied from one pump is distributed and introduced to each of the nozzles and then the washing water is sprayed, and the washing water may be distributed and introduced at the same flow rate to each of the first washing water spray nozzle and the second washing water spray nozzle. However, in order for the second washing water spray nozzle to spray the washing water while rotating smoothly by overcoming the frictional resistance of water when the washing water is contained in the washing tub, and in order to minimize clogging or contamination of spraying ports existing on the second washing water spray nozzle caused by contaminants existing in the washing water contained in the washing tub, it is preferable that the flow rate of the washing water that is introduced into the second washing water spray nozzle may be 1.2 to 1.5 times greater than the flow rate of the washing water that is introduced into the first washing water spray nozzle.

Each of the first and second washing water spray nozzles may respectively include an impeller provided with a plurality of spraying ports in which the impeller is configured to spray the washing water, and may be applied with various types of known structures of a spray nozzle in which a shaft is coupled to the impeller and the impeller is rotated around the shaft by spray pressure of the washing water, but is not specifically limited thereto.

In the present disclosure, the steam generator is provided in the washing tub, and is configured to supply steam to the inside of the washing tub by using the washing water supplied from the first and second washing water spray nozzles, and a position where the steam generator is provided is not specifically limited. However, in order to rapidly generate and supply steam, it is preferable that the steam generator is provided at the lower surface of the washing tub such that the steam generator is capable of generating steam with a small amount of the washing water supplied to the inside of the washing tub.

In the present disclosure, the ultrasonic vibration part is provided at the outer surface of the washing tub, and is configured to apply ultrasonic vibration to the washing water in the washing tub such that the ultrasonic washing is performed. In the present disclosure, since the ultrasonic washing is performed by applying ultrasonic vibration to the washing water filled to a substantial level that is a level submerging most of the dishes in the washing tub, the washing is capable of being performed even between the dishes accommodated in the washing tub without forming a blind spot, and there is no need to pay attention to standing each of the dishes at an advantageous angle. When the performing of the ultrasonic washing by the ultrasonic vibration part is completed, the contaminated washing water remaining in the washing tub is discharged to the outside through a discharge port formed in the washing tub.

In order to more enhance the washing performance for the dishes by uniformly and effectively transferring the ultrasonic vibration to the entire washing water in the washing tub, it is preferable that the ultrasonic vibration part is provided at the lower surface of the outer surface of the washing tub.

According to the household dishwasher of the present disclosure, it is preferable that the household dishwasher is further provided with an ultraviolet (UV) lamp performing sterilization. More specifically, it is preferable that the household dishwasher includes a first UV lamp for sterilizing dishes in which the first UV lamp is provided at a place on the inner surface of the washing tub and is configured to sterilize the dishes in the washing tub after the washing is completed, and includes a second UV lamp for sterilizing a filter in which the second UV lamp for sterilizing the filter is provided adjacent to the filter mounted on the discharge port that is formed in the washing tub and is configured to prevent the filter from being contaminated.

In the present disclosure, the controller is provided at the inner portion of the main body, and is configured to control an operation relationship between internal components by receiving a washing command signal of a user. Further, the controller responds to various washing modes that are selected by the user such that the washing is performed in various washing courses. However, in order to completely remove contaminants that are not well washed since the contaminants are adhered to the dishes for a long time, the controller controls such that the main washing step (\textcircled{3}) that will be described below is essentially performed. Except for the main washing step (\textcircled{3}) among the steps \textcircled{1} to \textcircled{6}, the remaining steps may be optionally selected to the washing course by being corresponding to the various washing modes that the user selected. However, the washing course that has the most excellent washing performance for the object to be washed is the washing course that performs all steps \textcircled{1} to \textcircled{6} in order.

\textcircled{1} Primary Steam Soaking Step

This is a step in which 5 ml to 300 ml of the washing water is contained in the washing tub through the first and second washing water spray nozzles, then the object to be washed is soaked by high-temperature steam that is generated through the steam generator, and then the washing water remaining in the washing tub is discharged.

\textcircled{2} Simplified Washing Step

This is a step in which the object to be washed is washed by spraying high-pressure washing water through the first and second washing water spray nozzles, and then the washing water is discharged.

\textcircled{3} Main Washing Step

This is a step in which 50 volume % to 80 volume % of the washing water based on a volume of the washing tub is contained in the washing tub through the first and second washing water spray nozzles, then the washing water contained in the washing tub is heated by a heater and the ultrasonic washing is performed by applying ultrasonic vibration to the washing water in the washing tub, and also the washing is performed by generating the vortices and the bubbles in the washing water in the washing tub by operating the first and second washing water spray nozzles, and then the washing water is discharged. As the heater as described above, various types of known heaters may be used.

\textcircled{4} Steam Sterilization Step

This is a step in which 5 ml to 300 ml of the washing water is contained in the washing tub through the first and second washing water spray nozzles, and then the object to be washed is sterilized by generating high-temperature steam through the steam generator.

\textcircled{5} Rinsing Step

This is a step in which the object to be washed is rinsed by spraying the washing water through the first and second washing water spray nozzles, and then the washing water is discharged.

\textcircled{6} Drying Step

This is a step in which moisture remaining on the object to be washed in the washing tub is dried and removed by using hot air. When the first ultraviolet (UV) lamp for sterilizing dishes is provided at the washing tub, it is more preferable that the sterilizing performed by the first UV lamp for sterilizing dishes is performed together with the drying step in order to perform more complete sterilization of the object to be washed.

In addition, in order to prevent a user from suffering a safety accident, it is preferable that the controller controls a locking device so that the washing tub is not pulled out frontward from the main body while the washing process is performed, and it is preferable that the controller controls the locking device so that the door portion is not opened while the washing process is performed.

According to the household dishwasher of the present disclosure, compared to the existing household dishwasher in a high-pressure washing water spraying type, the washing performance of the household dishwasher may be improved since the washing is uniformly performed throughout the dishes without forming a blind spot of the washing. Further, the household dishwasher of the present disclosure has an advantage that the convenience of use may be improved since there is no need to pay attention to standing each dish at an angle advantageous for performing the washing.

Hereinafter, the present disclosure will be described through an embodiment illustrated in the drawings so as to facilitate understanding of the present disclosure. The embodiment illustrated in the drawings that will be described below is only an example for describing the present disclosure, and the scope of the present disclosure is not limited thereto.

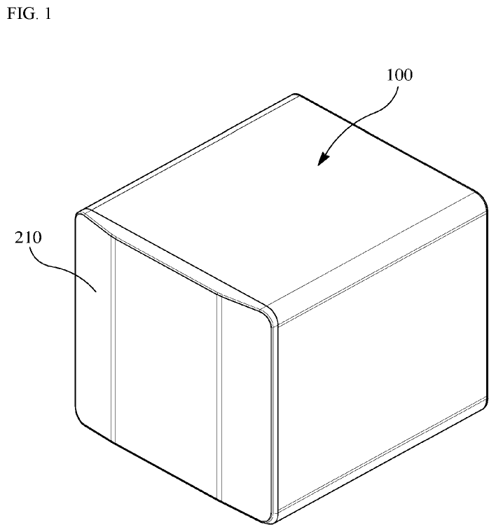

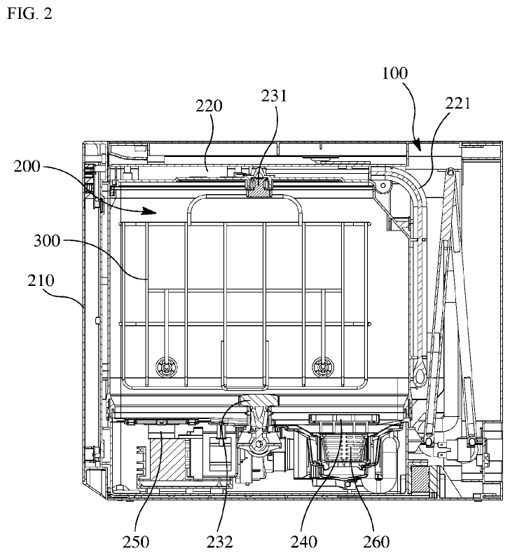

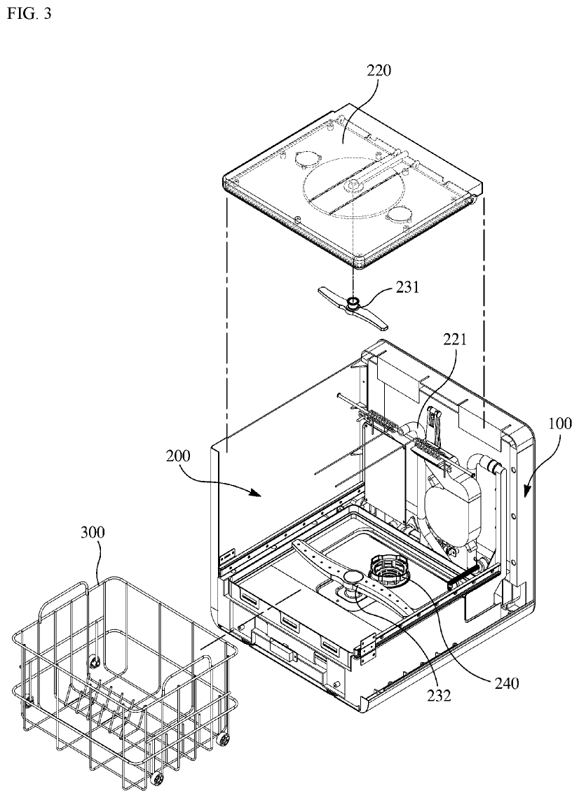

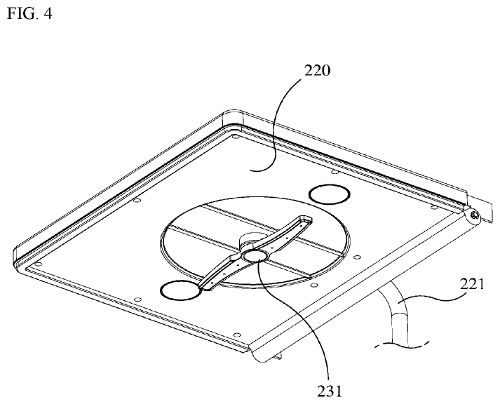

FIG. 1 is a perspective view illustrating a household dishwasher according to an embodiment of the present disclosure. FIG. 2 is a side cross-sectional view illustrating the household dishwasher according to an embodiment of the present disclosure. FIG. 3 is an exploded perspective view illustrating a state in which some components of the household dishwasher according to an embodiment of the present disclosure are separated from each other so as to illustrate an inner portion of the household dishwasher. FIG. 4 is a view illustrating a door portion of the household dishwasher according to an embodiment of the present disclosure.

Referring to FIGS. 1 and 2, a household dishwasher according to an embodiment of the present disclosure includes a main body 100 and a washing tub 200 accommodated inside the main body 100 and configured to be pulled in and out through an opening portion that is formed in the front of the main body 100. The washing tub 200 is a place where an object to be washed is accommodated and washed, and since the washing tub 200 is coupled to the main body 100 via a sliding structure, the washing tub 200 is pulled out from the main body 100 by being slid frontward, and is pulled in toward an inner portion of the main body 100 by being slid rearward. On a front surface portion of the washing tub 200, a front surface cover portion 210 having a predetermined thickness is formed. Further, on an upper surface of the washing tub 200, a door portion 220 capable of being opened and closed vertically is formed. The door portion 220 is capable of being opened after the washing tub 200 is pulled out through the opening portion that is positioned in the front of the main body 100. In addition, dishes to be washed are accommodated inside the washing tub 200 while being placed on a rack 300.

Referring to FIGS. 2 and 3, in the household dishwasher according to an embodiment of the present disclosure, a first washing water spray nozzle 231 is provided at the door portion 220. Particularly, referring to FIG. 4, the first washing water spray nozzle 231 is provided at a center portion of a lower surface of the door portion 220, and is connected to a door portion water supply pipe 221 that is flexible. In addition, in the household dishwasher according to an embodiment of the present disclosure, a second washing water spray nozzle 232 that is configured to spray washing water to the inside of the washing tub 200 and a steam generator 240 that is configured to supply steam to the inside of the washing tub 200 are provided at a lower surface of an inner surface of the washing tub 200.

In addition, referring to FIG. 2, an ultrasonic vibration part 250 configured to apply ultrasonic vibration to the washing water in the washing tub 200 such that an ultrasonic washing is performed is provided at a lower surface of an outer surface of the washing tub 200.

From the foregoing description, it will be understood by those skilled in the art that the present disclosure may be embodied in other specific forms without changing the technical spirit or essential characteristics of the present disclosure. The scope of the present disclosure is represented by the following claims, rather than the detailed description, and it is to be construed that the meaning and scope of the claims and all variations or modified forms derived from the equivalent concept thereof are encompassed within the scope of the present disclosure.

What is claimed is:

1. A household dishwasher provided with a washing tub where an object to be washed is accommodated and washed, and a main body accommodating the washing tub in a structure that the washing tub is capable of being pulled in and out through an opening portion that is formed in front of the main body, the household dishwasher comprising:
a door portion formed on an upper surface of the washing tub and configured to open and close the upper surface of the washing tub;
a first washing water spray nozzle provided at the door portion and configured to spray washing water supplied from a door portion water supply pipe to an inside of the washing tub;
a second washing water spray nozzle provided at a lower surface of the washing tub and configured to spray the washing water to the inside of the washing tub;
a steam generator provided in the washing tub and configured to supply steam to the inside of the washing tub by using the washing water supplied from the first and second washing water spray nozzles;
an ultrasonic vibration part provided at an outer surface of the washing tub and configured to apply ultrasonic vibration to the washing water inside the washing tub such that an ultrasonic washing is performed; and
a controller provided inside the main body and configured to receive a washing command signal of a user and control internal components of the household dishwasher.

2. The household dishwasher of claim 1, wherein a flow rate of the washing water from the second washing water spray nozzle is greater than a flow rate of the washing water from the first washing water spray nozzle.

3. The household dishwasher of claim 1, wherein a lower surface portion of the washing tub is provided with a leaning prevention portion configured to support the household dishwasher so that the household dishwasher is prevented from leaning frontward when the washing tub is pulled out frontward from the main body.

4. The household dishwasher of claim 1, wherein the ultrasonic vibration part is provided at a lower surface portion of the outer surface of the washing tub.

5. The household dishwasher of claim 1, further comprising: a first ultraviolet (UV) lamp for sterilizing dishes in which the first UV lamp for sterilizing the dishes is provided at a place on the inner surface of the washing tub and is configured to sterilize the object in the washing tub after the object to be washed is completely washed; and a second UV lamp for sterilizing a filter in which the second UV lamp for sterilizing the filter is provided adjacent to a filter mounted in a discharge port that is formed in the washing tub, the second UV lamp being configured to prevent the filter from being contaminated.

6. The household dishwasher of claim 1, wherein the controller controls the household dishwasher such that a washing course including a main washing step is performed, in which the main washing step is performed such that 50 volume % to 80 volume % of the washing water based on a volume of the washing tub is contained in the washing tub through the first and second washing water spray nozzles, then the washing water contained in the washing tub is heated by a heater and the ultrasonic washing is performed by applying the ultrasonic vibration to the washing water in the washing tub, and also a washing is performed by generating vortices and bubbles to the washing water in the washing tub by operating the first and second washing water spray nozzles, and then the washing water is discharged.
